(19) United States
(12) Patent Application Publication
(10) Pub. No.: US 2026/0229051 A1
(43) Pub. Date: Aug. 6, 2026

(54) AUTOMATED LABELING FOR LANGUAGE MODEL FINE-TUNING

(71) Applicant: NVIDIA Corporation, Santa Clara, CA (US)

(72) Inventors: Han ZHANG, Stanford, CA (US); Subhashree RADHAKRISHNAN, Milipitas, CA (US); Vidya NARIYAMBUT MURALI, Sunnyvale, CA (US); Parthasarathy SRIRAM, Los Altos Hills, CA (US); Yao LU, Palo Alto, CA (US)

(73) Assignee: NVIDIA Corporation, Santa Clara, CA (US)

(21) Appl. No.: 19/043,135

(22) Filed: Jan. 31, 2025

(51) Int. Cl. G06V 20/70; G06V 10/74; G06V 10/762; G06V 30/10

(52) U.S. Cl. CPC G06V 20/70; G06V 10/761; G06V 10/762; G06V 30/10

(57) ABSTRACT

In various examples, a computing system can receive a caption regarding an image. The computing system can generate, responsive to detecting that the caption includes at least a threshold amount of text, based at least on applying text recognition to the image, text data represented in the image. The computing system can cause at least one language model to generate an annotation for the image based at least on the caption, the text data, an example query for the language model to process, and an example response corresponding to the example query.

### BACKGROUND

Improving the accuracy and performance of an automated labeling data engine of images presents challenges. Some traditional methods rely on datasets for model training that include holistic descriptions of images. However, this approach may not be useful for configuring (e.g., training, updating, fine-tuning) VLMs, such as by lacking accurate question-answer annotation pairs. Additionally, designing and annotating questions and answers for large image datasets can be a resource-intensive process. Some current data generation pipelines provide a small set of examples to a language model for in-context learning of question-answer annotation; however, such approaches can lack the ability to provide detailed captions or to achieve high diversity of captions. Such approaches can also result in captions lacking in accuracy (e.g., result in hallucinations).

### SUMMARY

Implementations of the present disclosure relate to systems and methods for automated labeling for language model fine-tuning. Systems and methods are disclosed for autolabeling images, such as to provide an end-to-end supervised fine-tuning (SFT) labeling data engine that can generate diverse, high-quality question-answer annotations following instructions for images. This can be useful, for example, for fine-tuning vision language models (VLMs) (and/or other language models, such as multi-modal language models (MMLMs)).

In contrast to conventional systems, systems and methods in accordance with the present disclosure can implement a data generation pipeline that achieves a more accurate performance, and that can generate annotations for images having large amounts of text. The system can obviate the need for manual labeling and/or reliance on ground-truth image caption annotations. For example, the system can retrieve captions for images that may be clustered according to visual features and/or filtered according to the clustering, to provide a reduced size dataset of diverse images. The system can evaluate a score of the captions, e.g., using a language model, and can retain captions satisfying a score threshold and/or provide images having captions not satisfying the score threshold for manual annotation.

Additionally, the systems and methods can allow for improved accuracy of captions for text-heavy images. For example, the system can selectively identify images having at least a threshold amount of text information, e.g., based at least on the amount of text of the caption, and can provide the identified images to an optical character recognition (OCR) component to generate text from the images. The system can provide captions (e.g., as filtered and/or corrected according to various processes described herein) along with question-answer annotations to a language model to update the language model for generation of annotations. This can include, for example, providing task-specific example annotations, such as for conversation, complex reasoning, multiple choice, and/or short answer conversation tasks. This can allow for the language model to be capable of following user-specified questions, and to provide a pipeline scalable to handling large image datasets.

At least one aspect relates to one or more processors including processing circuitry. The processing circuitry can receive a caption regarding an image. The processing circuitry can generate, responsive to detecting that the caption includes at least a threshold amount of text, based at least on applying text recognition to the image, text data represented in the image. The processing circuitry can cause at least one language model to generate an annotation for the image based at least on the caption, the text data, an example query for the at least one language model to process, and/or an example response corresponding to the example query.

In some implementations, the processing circuitry is to apply the image as input to a vision language model to cause the vision language model to generate the caption. In some implementations, the processing circuitry is to generate a plurality of clusters of a plurality of candidate images according to visual similarity amongst the plurality of candidate images, may remove at least one candidate image from one or more clusters of the plurality of clusters to retain a subset of candidate images for the one or more clusters, and can retrieve the image from the subset of candidate images.

In some implementations, the processing circuitry is to apply the caption and the image as input to at least one language model to cause the at least one language model to generate an accuracy score regarding the caption, may provide a request for a manual caption of the image responsive to the accuracy score being less than an accuracy threshold, and can cause the at least one language model, responsive to receiving the manual caption, to generate the annotation according to the manual caption.

In some implementations, the processing circuitry is to cause the at least one language model to generate the annotation by performing in-context learning using the caption, the text data, the example query, and/or the example response. In some implementations, the processing circuitry is to cause the at least one language model to generate the annotation to include a question regarding the image and an answer to the question.

At least one aspect relates to a system that includes one or more processors. The one or more processors can receive a caption regarding an image. The one or more processors can generate, responsive to detecting that the caption includes at least a threshold amount of text, based at least on applying text recognition to the image, text data represented in the image. The one or more processors can cause at least one language model to generate an annotation for the image based at least on the caption, the text data, and an example query-response pair, such that the annotation corresponds to the example query-response pair.

In some implementations, the one or more processors are to apply the image as input to a vision language model to cause the vision language model to generate the caption. The one or more processors can generate a plurality of clusters of a plurality of candidate images according to visual similarity amongst the plurality of candidate images. The one or more processors can remove at least one candidate image from one or more clusters of the plurality of clusters to retain a subset of candidate images for the one or more clusters. The one or more processors can retrieve the image from the subset of candidate images.

In some implementations, the one or more processors can apply the caption and the image as input to at least one language model to cause the at least one language model to generate an accuracy score regarding the caption. The one or more processors can provide a request for a manual caption of the image responsive to the accuracy score being less than an accuracy threshold. The one or more processors can cause the at least one language model, responsive to receiving the manual caption, to generate the annotation according to the manual caption.

In some implementations, the one or more processors are to cause the at least one language model to generate the annotation by performing in-context learning using the caption, the text data, and the example query-response pair. The one or more processors can cause the at least one language model to generate the annotation to include a question regarding the image and an answer to the question.

At least one aspect relates to a method. The method can include retrieving a caption of an image. The method can include performing optical character recognition on the image responsive to the caption having greater than a threshold amount of text, to generate text data of the image. The method can include generating, using at least one neural network, an annotation for the image according to the text data, the image, and natural language data representing an example of the annotation.

In some implementations, the method includes modifying the caption according to user input regarding the image. In some implementations, the method includes generating the caption by applying the image as input to a vision language model.

In some implementations, the method includes updating at least one language model using the annotation. In some implementations, the method includes selecting the image according to a visual characteristic of the image relative to a plurality of candidate images.

The processors, systems, and/or methods described herein can be implemented by or included in at least one a system. The system can include a system for generating synthetic data. The system can include a system implementing one or more large language models (LLMs). The system can include a system implementing one or more small language models (SLMs). The system can include a system implementing one or more vision language models (VLMs). The system can include a system for performing conversational AI operations. The system can include a system implementing one or more multi-model language models. The system can include a perception system for an autonomous or semi-autonomous machine. The system can include a system for performing simulation operations. The system can include a system for performing digital twin operations. The system can include a system for performing light transport simulation. The system can include a system for performing collaborative content creation for 3D assets. The system can include a system for performing deep learning operations. The system can include a system for performing remote operations. The system can include a system for performing real-time streaming. The system can include a system for generating or presenting one or more of augmented reality content, virtual reality content, or mixed reality content. The system can include a system implemented using an edge device. The system can include a system implemented using a robot. The system can include a system for generating synthetic data using AI. The system can include a system incorporating one or more virtual machines (VMs). The system can include a system implemented at least partially in a data center. The system can include a system implemented at least partially using cloud computing resources.

### BRIEF DESCRIPTION OF THE DRAWINGS

The present systems and methods for automated labeling for language model fine-tuning are described in detail below with reference to the attached drawing figures, wherein:

FIG. 1 is a block diagram of an example of a system, in accordance with some implementations of the present disclosure;

FIG. 2 is a flow diagram of an example of a method for autolabeling images in an annotation generation pipeline, in accordance with some implementations of the present disclosure;

FIG. 3A is a block diagram of an example generative language model system suitable for use in implementing at least some implementations of the present disclosure;

FIG. 3B is a block diagram of an example generative language model that includes a transformer encoder-decoder suitable for use in implementing at least some implementations of the present disclosure;

FIG. 3C is a block diagram of an example generative language model that includes a decoder-only transformer architecture suitable for use in implementing at least some implementations of the present disclosure;

FIG. 4 is a block diagram of an example computing device suitable for use in implementing at least some implementations of the present disclosure; and

FIG. 5 is a block diagram of an example data center suitable for use in implementing at least some implementations of the present disclosure.

### DETAILED DESCRIPTION

Systems and methods are disclosed related to autolabeling images, such as to provide an end-to-end supervised fine-tuning (SFT) labeling data engine that can generate diverse, high-quality instruction-following question-answer annotations for images. This can be useful, for example, for fine-tuning vision language models (VLMs) (and/or other language models, such as multi-modal language models (MMLMs)).

Some datasets for model training include holistic descriptions of images. However, this data may not be useful for configuring (e.g., training, updating, fine-tuning) VLMs as they lack accurate question-answer annotation pairs. On the other hand, designing and annotating questions and answers for large image datasets can be a resource-intensive process. Some data generation pipelines provide a small set of examples to a language model for in-context learning of question-answer annotation; however, such approaches can lack the ability to provide detailed captions or to achieve high diversity of captions and can result in captions lacking in accuracy (e.g., result in hallucinations).

Systems and methods in accordance with the present disclosure can implement a data generation pipeline that achieves more accurate performance, and that can generate annotations for images having large amounts of text. The system can obviate the need for manual labeling and/or reliance on ground-truth image caption annotations.

For example, the system can retrieve captions for images that may be clustered according to visual features and/or filtered according to the clustering, to provide a reduced size dataset of diverse images. The system can evaluate a score of the captions, e.g., using a language model, and can retain captions satisfying a score threshold and/or provide images having captions not satisfying the score threshold for manual annotation.

The system can allow for improved accuracy of captions for text-heavy images, e.g., images having a relatively large amount of text. For example, the system can selectively identify images having at least a threshold amount of text information, e.g., based at least on the amount of text of the caption, as being text-heavy images, and can provide the identified images to an optical character recognition (OCR) component to generate text from the images.

The system can provide captions (e.g., as filtered and/or corrected according to various processes described herein) along with question-answer annotations to a language model to update the language model for generation of annotations. This can include, for example, providing task-specific example annotations, such as for conversation, complex reasoning, multiple choice, and/or short answer conversation tasks. This can allow for the language model to be capable of following user-specified questions, and to provide a pipeline scalable to handling large image datasets.

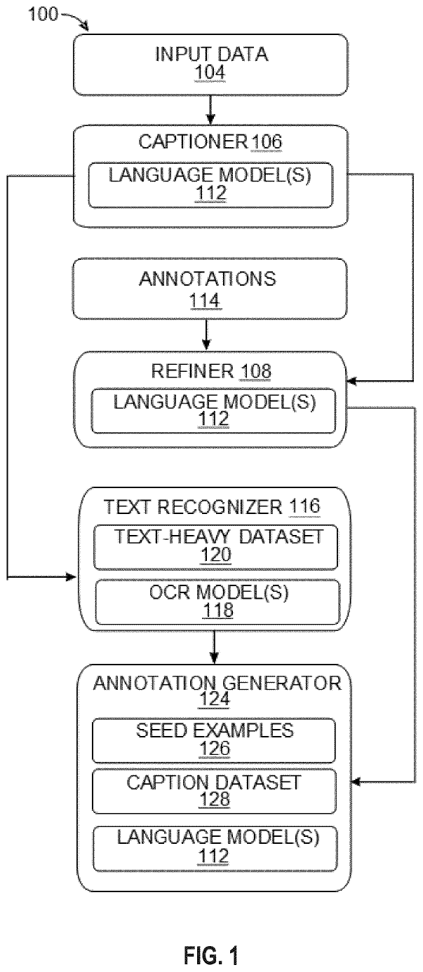

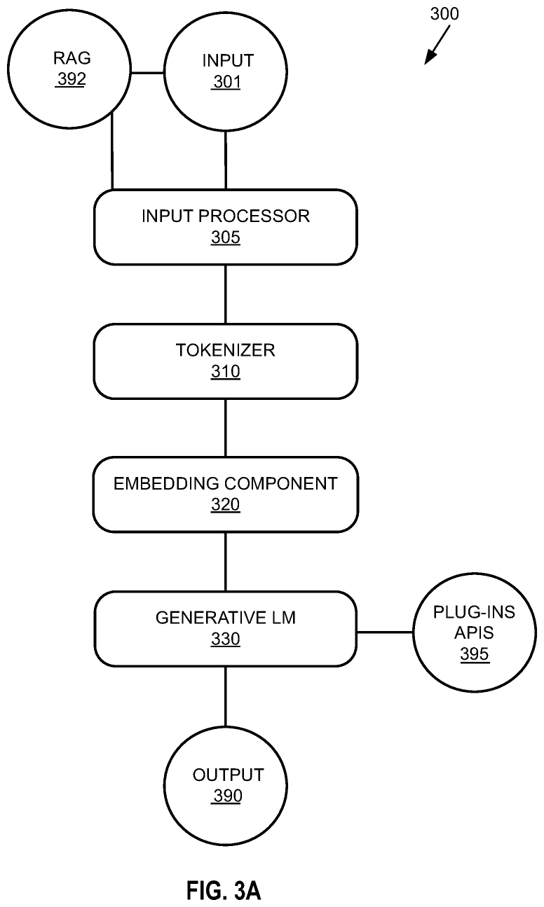

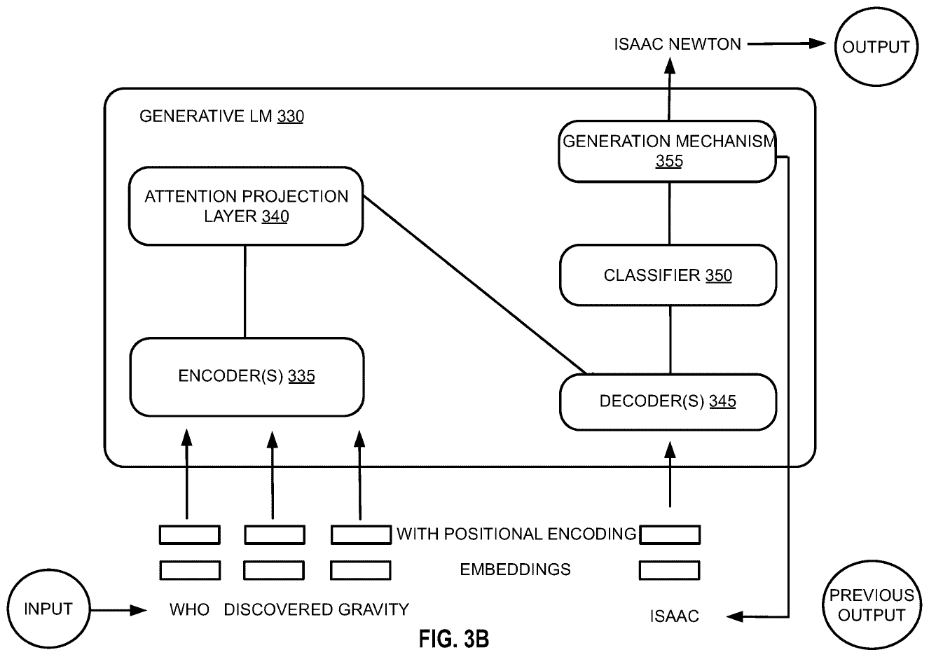

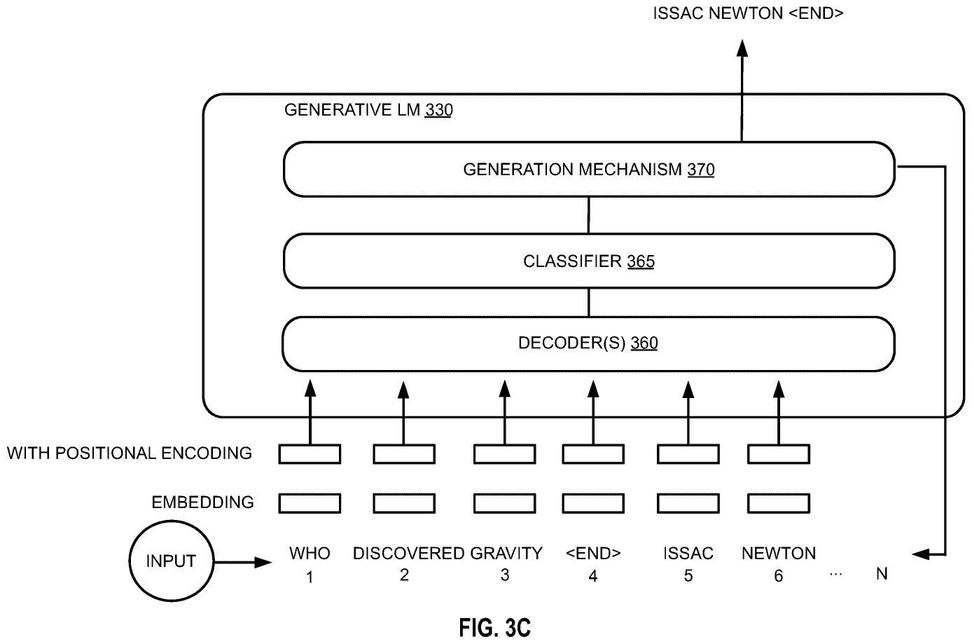

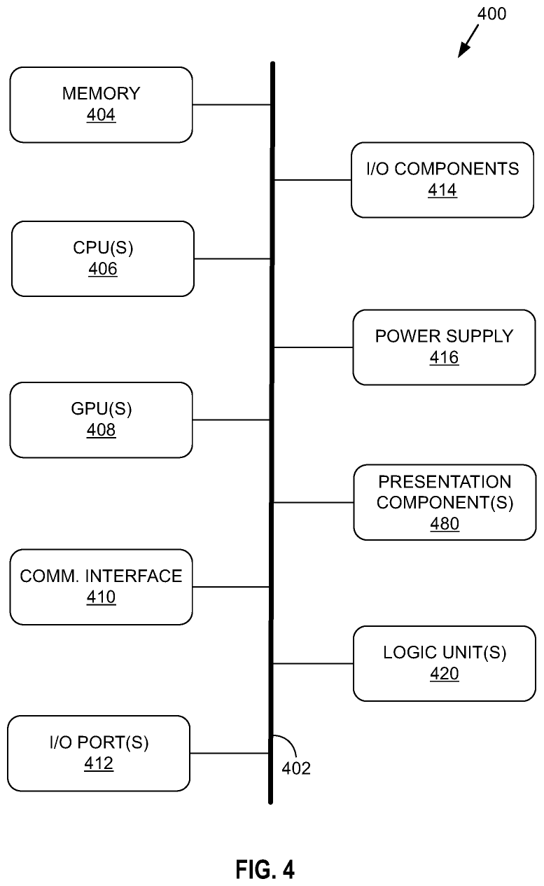

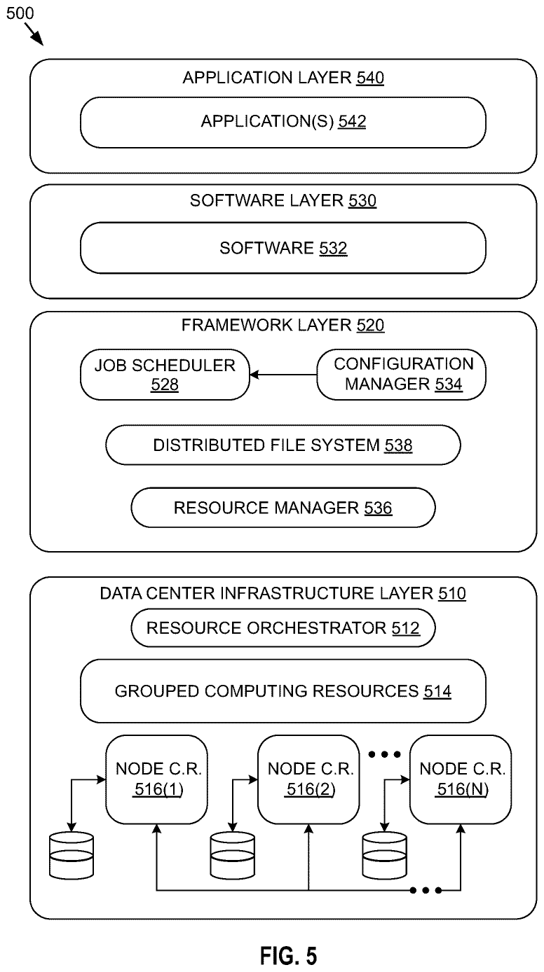

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some implementations, the system and methods described herein may be implemented using one or more generative language models (e.g., as described in FIGS. 3A-3C), one or more computing devices or components thereof (e.g., as described in FIG. 4), and/or one or more data centers or components thereof (e.g., as described in FIG. 5).

In the example illustrated in FIG. 1, the system 100 includes a captioner 106, a refiner 108, a text recognizer 116, and an annotation generator 124. The system 100 can apply one or more language models 112 to provide an end-to-end supervised fine-tuning (SFT) labeling data engine that can generate diverse, high-quality instruction-following question-answer annotations for images. In some implementations, for example and without limitation, the system 100 can receive input data 104 that includes a plurality of images, can generate image captions based on the plurality of images, can refine (e.g., correct, filter) the image captions based at least on the quality of the image captions, and/or can update (e.g., train, fine-tune, perform transfer learning on,) one or more language models 112 to generate question-answer annotations for the image dataset based at least on the image captions, example queries (e.g., questions) for the language model to process, and example responses (e.g., answers) corresponding to the example queries. The system 100 can include a sub-pipeline for text-heavy (e.g., according to a predetermined threshold) images. The system 100 can cause a language model 112 to identify heavy-text images based on the image captions. The system 100 can generate text recognition of the images (e.g., text data), and generate annotations for the text-heavy images based at least on the image captions, the text data, and example queries and responses for the language model to process.

The system 100 can implement at least a portion of an autolabeling pipeline such as an annotation generating pipeline, a text recognizing pipeline, and/or an end-to-end supervised fine-tuning (SFT) pipeline. The system 100 can be used to generate SFT instruction-following annotations by any of various systems described herein, including but not limited to automotive vehicle systems, medical imaging systems, surveillance systems, interactive display systems, environmental monitoring systems, augmented reality systems, virtual reality systems, and/or mixed reality systems.

The system 100 can include or be coupled with one or more data sources such as input data 104. The input data 104 can include or the system 100 can receive the input data 104 from any of various databases, data sets, data repositories, or from a remote device via a network connection, for example. As described further herein, the system 100 can use at least a subset of the input data 104 to configure language models 112, such as to configure the language models 112 to generate caption data based at least on the input data 104.

The input data 104 can include, without limitation, data such as any one or more of image data, video data, or various combinations thereof. Images (including video) of the input data 104 can correspond to one or more views of a scene captured by an image capture device (e.g., camera), or images generated computationally, such as simulated or virtual images or video (including by being modifications of images from an image capture device). The images can each include a plurality of pixels, such as pixels arranged in rows and columns. The images can include image data assigned to one or more pixels of the images, such as color, brightness, contrast, intensity, depth (e.g., for three-dimensional (3D) images), or various combinations thereof. The input data 104 can include videos and/or video data structured as a plurality of frames (e.g., image frames, video frames), such as in a sequence of frames, where each frame is assigned a time index (e.g., time step, time point) and has image data assigned to one or more pixels of the images.

The system 100 can perform input data processing which can include processing (e.g., filtering, clustering, etc.) the input data 104, such as where the input data 104 is in a raw form, before providing the processed input data to the captioner 106. For example, the system 100 can perform clustering by causing one or more pre-trained feature generation models, such as image-text feature generation models (e.g., contrastive language-image pre-training (CLIP) models, etc.), to generate embeddings that include semantic information for classification within each segmented portion of the input image. The embeddings can then be clustered (e.g., classified, grouped) based on their similarity to text embeddings and/or visual embeddings of other input images. The input data processing can include selecting a subset of images from each of the resulting image clusters which can be advantageous for ensuring image diversity to be inputted to the captioner 106. In another example, the input data processing may include resolving (e.g., removing) problematic (e.g., low resolution, duplicate, incorrectly labeled, noise containing, etc.) images to ensure quality and accuracy of images inputted to the captioner 106.

Referring further to FIG. 1, the system 100 can include at least one captioner 106 to generate image captions using a language model 112 (e.g., a first language model 112). The captioner 106 can provide a plurality of captions based on a plurality of input data 104 (e.g., corresponding to image data and/or video data) using a language model and/or large language model (LLM) (or neural network models, multimodal language models, vision language models, small language models, etc.). The captions can provide a detailed description of the images (e.g., including key elements, features).

The system 100 can determine a correctness score of the captions, e.g., using a language model 112 (e.g., a second language model 112), based on the image data and/or video data and the corresponding caption. For example, the system 100 can provide image data and/or video data and caption as input to the language model 112 and a request for the language model 112 to evaluate the corresponding caption.

The system 100 can provide the captions that satisfy a correctness score threshold and the corresponding images to an annotation generator 124. The system 100 can provide the captions not satisfying the score threshold and the corresponding images to a refiner 108 for caption refinement. In some implementations, the language model 112 may determine the correctness score based on accuracy the image data, relevance of the caption relative to the primary content of the image, readability of the image, and/or a variety of similar factors. In some implementations, the system 100 can retain the captions satisfying a correctness score threshold and/or and the corresponding images in a dataset (e.g., a first dataset) to be provided to the annotation generator 124 and the captions not satisfying a correctness score threshold and/or and the corresponding images in a dataset (e.g., a second dataset) to be provided to the refiner 108.

In some implementations, the captions can be expanded with region-text annotations. For example, the captioner 106 can provide expanded captions by utilizing region-text data, or data regarding a specific region within an image and/or video. The region-text data can be provided in the form of bounding boxes. The bounding boxes can be assigned information regarding objects or features in the bounding box. For example, region-text data may include bounding box data such as, “box_id: 0, bbox: [0.21, 0.24, 0.79, 0.65], gdino_label: guacamole, llama_object: Sushi dish, local_caption: The image showcases a beautifully presented sushi dish featuring thinly sliced raw salmon, garnished with a vibrant green sauce that could be wasabi, and topped with chopped green herbs like chives or parsley, all arranged on a white plate to highlight the dish's presentation and colors.” Within the image data and/or video data, the input data 104 can include bounding boxes. The bounding boxes can correspond to detected objects and can represent a boundary of the detected object within the image data and/or video data. Bounding boxes can be generated around a potential object in an image and/or video. The captioner 106 can assign relationships between the detected objects within the image data and/or video data based on the bounding boxes. The bounding boxes can assist the captioner 106, using a language model 112, with identifying the location of objects and providing spatial relationships within the captions. For example, the expanded captions may include spatial relationships between the objects, such as one object being to the left, to the right, next to, above, etc., a second object. The captioner 106 can use bounding boxes to provide highly detailed captions that highlight relevant features such as contextual descriptions and spatial.

In some implementations, the captions can be expanded by implementing specialist models. That is, the captioner 106 can provide a merged caption, using a language model (LM) 112 to generate high-quality, detailed captions (e.g., including spatial relationships, object details, text data, etc.) based on image data and/or video data. The image data and/or video data and/or the caption can be provided to one or more specialist models (e.g., spatial specialist, grounding specialist, optimal character recognition (OCR) specialist). The spatial specialist can generate text (e.g., descriptions) that emphasize spatial relationships within the image data and/or video data (e.g., how one or more objects are positioned relative to the one or more objects) based on the image data and/or video data and/or the caption. The grounding specialist can generate text (e.g., descriptions) focusing on object detection and localization within the image data and/or video data (e.g., using bounding box details) based on the image data and/or video data and/or the caption. The OCR specialist can generate text (e.g., descriptions) focusing on text recognition within the image data and/or video data (e.g., extracts and interprets text data from the image data and/or video data using OCR) based on the image data and/or video data and/or the caption. The descriptions from one or more of the specialist models and/or the caption can be merged (e.g., combined) using a language model (LM) 112.

In an example, an image caption (e.g., initial description of an image) based on image data (from the input data 104) might be “In this image, we can see some people standing, there are some holding flags and walking, we can see some buildings, there are some windows on the buildings.” The spatial specialist model may provide an image caption based on the same image data, “The image captures a vibrant scene from a parade. A group of people, adorned in colorful clothing and holding flags, are the main focus. They are walking down a street, their path framed by buildings on either side. The buildings, mostly white and gray, stand tall against the backdrop of a clear blue sky. \n\nThe parade participants are moving in unison, their flags waving in the air, adding a dynamic element to the scene. The flags, in hues of red, yellow, and blue, stand out against the neutral tones of the buildings and the sky. \n\nThe perspective of the image is from the side of the parade, giving a sense of the parade's scale and the number of participants. The people, buildings, and flags are all positioned in such a way that they create a harmonious composition, with the parade participants at the center, the buildings on the sides, and the sky above. \n\nOverall, the image is a lively depiction of a parade, capturing the energy and color of the event against the backdrop of an urban setting.” The grounding model may provide an image caption based on the same image data, “A crowd of people[000,560,999,998] with rainbow flags[670,373,770,575]; [464,518,518,616]; [116,531,194,732] and orange and yellow flags[001,560,058,716]; [328,550,401,731] marching down a street.” The OCR model may provide an image caption based on the same image data, “On the building facade, there is text that reads \“THE FALLOUT\” and \“new york, new york\” below it. On the right side of the image, there is a sign with the text \“PARK\” on it” or “There is no discernible text within the image.”

In some implementations, the captioner 106 can prompt the language model 112 to provide a merged caption with a plurality of instructions (e.g., “You are tasked with creating a unified and detailed caption from three different captions provided for the same image. Here are the captions: Detailed Description (lengthy and potentially erroneous): “{spatial}”; Short Caption with Bounding Boxes in the format of [xmin, ymin, xmax, ymax] (relative positions out of 1000, the present object and bounding boxes are 100% accurate but can miss some objects): “{grounding}”; Text in Image (high-confidence text content from the image): “{ocr}”. Your goal is to utilize the three captions to correct and enrich the “Detailed Description”. Please adhere to the following guidelines: 1. Eliminate any empty, repetitive or irrelevant information. 2. Preserve the logical flow and coherence of the “Detailed Description”. 3. Keep all the details but do not introduce speculative information not present in the original captions. Present the merged image caption directly below.”) based on an image data and/or video data and the corresponding captions (e.g., from the specialist models).

The system 100 can identify, from the plurality of images (e.g., input data 104), images that have text based at least on the image captions. In some implementations, criterion and/or criteria can define which images are text-heavy (e.g., images including at least a threshold amount of text, characters, quotes, etc.). For example, the system 100 and/or the captioner 106 can identify the text-heavy images from the input data 104 (e.g., using the language model(s) 112) based on the image captions including at least a number of quotes and/or at least a number of words in a quote. The processing circuits of the captioner 106 can then filter and/or extract the text-heavy images to be stored (e.g., in a temporary storage, database, system, etc.) and/or be inputted into the text recognizer 116.

Referring further to FIG. 1, the system 100 can include at least one refiner 108. The refiner 108 can iteratively update the caption until the caption satisfies the correctness score threshold. For example, the refiner 108 can provide a refined caption for a caption not satisfying a correctness score threshold (e.g., having a low score correctness). The captions with a below threshold correctness score can be provided with manual annotations, e.g., from a human annotator, to correct (e.g., improve, alter) a caption until it satisfies the correctness score threshold. This iterative refinement process ensures that the final caption satisfies the correctness score requirement. Providing an initial caption increases the efficiency and accuracy of annotators when generating a refined caption and can save annotators time by using the synthetic caption as a starting point. In some implementations, the image data and/or video data with a low correctness score may be removed from the annotation generation pipeline.

In some implementations, the system 100 can include a text recognizer 116. The text recognizer 116 can process images to generate an output representing the text in the images. For example, the text recognizer 116 can generate annotations that include text for the text-heavy images, such as images for which the amount of text of the caption generated by the captioner 106 is greater than a threshold amount of text. Responsive to one or more neural networks (e.g., of a language model 112) determining that an image includes at least a threshold amount of text based at least on a caption for the image including at least a threshold amount of text (e.g., including at least a threshold number of quotes and/or at least a threshold number of words in any quote)., the system 100 can generate annotations for a subset of the plurality of images of images including heavy text (e.g., a text-heavy dataset 120). The system 100 can apply text recognition to the images in the text-heavy dataset 120 to generate text data (e.g., text represented in the text-heavy dataset 120). In some implementations, the text recognizer 116 includes an optical character recognition (OCR) model 118 to perform the text recognition. In some implementations, the text recognizer 116 applies any of various neural network-based operations to detect the text and/or characters of the images. In some implementations, the text recognizer 116 can apply any of various shape, template, or character matching-based operations to detect the text and/or characters of the images. The text recognizer 116 can identify regions in the images (e.g., of the text-heavy dataset 120) containing text by scanning the image for areas with features resembling text (e.g., using bounding boxes) and converting the detected regions into text. The processing circuits (e.g., of the text recognizer 116) can validate (e.g., perform text alignment, spell check, context validation, etc.) the text data provided by the OCR model 118. The text-heavy dataset 120 can include the text data, the corresponding subset of images, and/or the corresponding captions. The system 100 can allow a language model 112 to effectively assess and process images containing text and provide captions with improved accuracy for text-heavy images.

Referring further to FIG. 1, the system 100 can include at least one annotation generator 124. The annotation generator 124 can include and/or cause a language model 112 to generate annotations based on the image data and/or video data. One or more seed examples 126 can be provided (e.g., by human annotators) to the system including one or more example annotations (e.g., including example queries and corresponding responses) regarding one or more images and/or videos of the image data and/or video data. The one or more seed examples 126 can be generated regarding one or more tasks (e.g., conversation, complex reasoning, multiple choice questions, short-answer conversations, etc.) to provide a language model with expected formats and response types for the one or more tasks. The seed examples 126 can be used to train (e.g., implement, use, update, and/or configure) one or more language models 112 to cause the one or more language models 112 to generate consistent, high-quality annotations.

In some implementations, the annotation generation stage can be the stage in the autolabeling pipeline in which the system 100 can generate queries and corresponding responses, using by one or more language models 112, based on a plurality of images and/or videos, a plurality of corresponding captions (caption dataset 128), example queries and corresponding responses (seed examples 126), and/or text data. The plurality of question-answer annotations can be instruction following, such as generated according to specific tasks and/or in a defined structure (e.g., format, style).

In some implementations, the annotation generator 124 can generate OCR-specific annotations for the subset of images containing heavy-text. One or more seed examples 126 can be provided (e.g., by human annotators) to the system including one or more example annotations (e.g., including example queries and corresponding responses) regarding one or more images of the subset of images. The one or more seed examples 126 can be used to train (e.g., implement, use, update, and/or configure) one or more language models 112 to cause the one or more language models 112 to generate consistent, high-quality annotations specifically for images including text. The annotation generator 124 can cause a language model 112 to generate question-answer annotations for the subset of images based at least on the image captions, the text data, and the one or more seed examples 126.

In some implementations, the annotation generator 124 can generate and/or create a training dataset by pairing generated queries with corresponding generated responses. For example, the annotation generator 124 can pair output of language model(s) 112 as question-answer pairs, such as for training and/or model updating purposes. For example, the annotation generator 124 can use a plurality of seed examples 126, a plurality of images and/or videos, and a plurality of corresponding captions to generate queries and related responses to create paired data (e.g., to store in training dataset) for training, updating, implementing, configuring, and/or using one or more machine learning models (e.g., a vision language model (VLM)) to follow user-specified instructions.

In some implementations, the annotation generator 124 can prompt the language model 112 with a plurality of instructions (e.g., “You are an AI visual assistant, and you are seeing a single image. What you see are provided with its caption, describing the same image you are looking at. Answer all questions as you are seeing the image,” “Design a conversation between you and a person asking about this photo. The answers should be in a tone that a visual AI assistant is seeing the image and answering the question,” “Ask diverse questions and give corresponding answers,” “Include questions asking about the visual content of the image, including the object types, counting the objects, object actions, object locations, relative positions between objects, etc. ,” “Only include questions that have definite answers: (1) one can see the content in the image that the question asks about and can answer confidently; (2) one can determine confidently from the image that it is not in the image,” “Do not ask any question that cannot be answered confidently,” “include complex questions that are relevant to the content in the image, for example, asking about background knowledge of the objects in the image, asking to discuss about events happening in the image, etc. Again, do not ask about uncertain details,” “Provide detailed answers when answering complex questions. For example, give detailed examples or reasoning steps to make the content more convincing and well-organized. You can include multiple paragraphs if necessary,” “When using the information from the caption, directly explain the scene, and do not mention that the information source is the caption. Always answer as if you are directly looking at the image”) based on the content (e.g., visual content of the image and the caption describing the visual content of the image) and corresponding with at least one parameter (e.g., criteria or guidelines). That is, the annotation generator 124 can determine or identify the content of the image by analyzing keywords or terms within the image caption and aspects of the image (e.g., objects, setting, actions, etc.).

In some implementations, the annotation generator 124 can prompt the language model 112 with one or more instructions from the plurality of instructions based on image data and/or video data and the corresponding caption. In an example, a caption is generated by the captioner 106 based on an image containing a tank top, “The image showcases a tank top designed for women with a bold statement printed on the front. The text reads, “PEOPLE SHOULD STOP EXPECTING NORMAL FROM ME. WE ALL KNOW IT'S NEVER GOING TO HAPPEN!” in a block format with a sans-serif font. The text is capitalized and uses a bold font. The tank top has a scoop neckline and appears to be intended for a retail listing or catalog. The background is plain and does not provide any additional context or setting. The overall style is straightforward and product-focused.” The annotation generator 124 can provide task-specific annotations (e.g., based on a parameter as inputted by a user), such as for conversation, complex reasoning, multiple choice, and/or short answer conversation tasks, based on the instructions. Examples of conversation annotations may include questions such as “what is the main feature of the tank top being showcased?”, “what is the style of the font used for the text?”, and “what type of neckline does the tank top have?”, with corresponding answers being “the main feature is the bold statement printed on the front: ‘PEOPLE SHOULD STOP EXPECTING NORMAL FROM ME. . . WE ALL KNOW IT'S NEVER GOING TO HAPPEN!’ in a block format with a sans-serif font,” “the font is a bold, sans-serif style in all capital letters, enhancing the statement's boldness,” and “the tank top has a scoop neckline.” Examples of short answer annotations may include questions such as “what is the main subject of the image?”, “what is printed on the front of the tank top?”, and “is the font bold?”, with corresponding answers being “tank top,” “text,” and “yes.” Examples of complex reasoning and multiple-choice annotations may include questions such as “what kind of personality traits or values might someone who wears this tank top want to convey?” and “what is the tone of the message printed on the tank top?”, with corresponding answers being “Someone who wears this tank top is likely to want to convey a sense of confidence, individuality, and nonconformity. The bold and capitalized text on the front of the tank top suggests that the wearer is unapologetic and unafraid to express their true self, even if that means going against societal norms or expectations. The message also implies that the wearer values authenticity and autonomy, refusing to be bound by others' expectations of what is considered “normal.” Additionally, the use of a bold, sans-serif font and all capital letters gives the impression that the wearer is outspoken, assertive, and perhaps even a bit rebellious. Overall, this tank top is likely to appeal to individuals who want to make a statement about their independence and willingness to challenge the status quo,” and “B. sarcastic.”

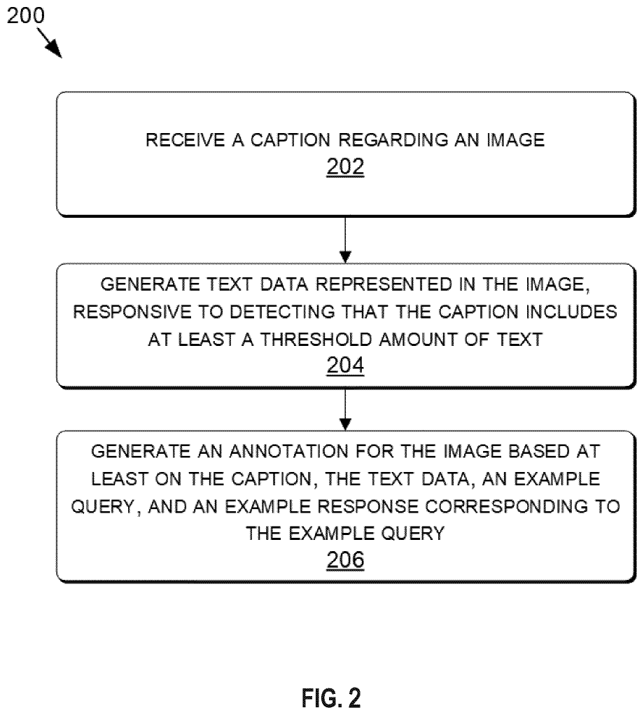

Now referring to FIG. 2, each block of method 200, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method may additionally or alternatively be executed by any one system, or any combination of systems, including, but not limited to, those described herein.

FIG. 2 is a flow diagram showing a method 200 for generating annotations based on images containing at least a threshold amount of text, in accordance with some implementations of the present disclosure. The method 200, at block 202, includes receiving a synthetic global caption (e.g., textual description) regarding an image. That is, receiving an input (e.g., an image) can cause the processing circuits to generate one or more words (e.g., using a language model 112) to provide a high-level description of the input (e.g., including key elements, features). Additionally, the processing circuits can score a quality of the caption based on a predefined scoring criterion. For example, the processing circuits can use a language model 112 (LLM) (or neural network models, multimodal language models, vision language models, small language models, etc.) to generate a correctness score of a caption (e.g., on a scale of 1-5, with 5 being the highest correctness score) based on the image and the global synthetic caption. The correctness score may be based on accuracy (e.g., whether the caption correctly describes main elements of the image), relevance (e.g., whether the caption focuses on the primary content of the image), fluency (e.g., whether the caption includes proper grammar and readability), and/or other similar factors. The processing circuits can determine the captions having a low correctness score (e.g., less than 5), and manual annotations (e.g., using human annotators) can be generated to correct (e.g., improve, raise the correctness score to a 5) the image caption. Providing an initial image caption regarding an image from a language model can be advantageous by increasing the efficiency of generating manual annotations. The method 200 allows human annotators to output more accurate captions by being provided an initial image caption rather than generating an image caption from scratch and saves the human annotators time by only providing images with a low caption correctness score to the annotators.

The method 200, at block 204, includes generating text data of the image, using an OCR model 118, responsive to detecting that the caption includes at least a threshold amount of text. The processing circuits can apply text recognition to the image, using the OCR model, and can prompt the LLM to identify text-heavy images based on the caption including at least a threshold amount of text (e.g., including at least 3 quotes and/or at least 5 words in any quote). That is, the processing circuits can guide the LLM to locate (e.g., flag, select, mark) a subset of images that contain heavy text to be introduced to a sub-pipeline. The processing circuits can use the OCR model 118, optimized for OCR-related tasks, to generate text recognition (e.g., text data) of the images in the subset of images containing heavy text.

The method 200, at block 206, includes generating an annotation for the image based at least on the caption, the text data, an example query, and an example response corresponding to the example query. Example queries and example responses (e.g., seed examples 126) can be manually generated (e.g., by human annotators) for at least one image containing at least a threshold amount of text. In some implementations, the processing circuits can use the example queries and example responses for in-context learning (e.g., training). Then, based on instructions, the processing circuits can prompt the LLM to generate a plurality of question-answer annotations based on the plurality of synthetic global captions, the plurality of text data, and the plurality of seed examples. Utilizing an OCR-specific model to recognize text provides more accurate annotations for the subset of images containing heavy text.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### EXAMPLE LANGUAGE MODELS

In at least some implementations, language models, such as language models 112 (with reference to FIG. 1), large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in implementations, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in implementations, whereas in other implementations, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various implementations. For example, different architectures may be implemented that use different techniques for understanding and generating outputs-such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) may be used, while in other implementations transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular implementation and the task(s) being performed using the LLMs/SLMs/VLMs/MMLMs/etc.

In various implementations, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains. One or more language models 112 described with reference to FIG. 1 can be trained as described here.

In some implementations, the LLMs/SLMs/VLMs/MMLMs/etc. of the present disclosure, may be implemented using various model alignment techniques. For example, in some implementations, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some implementations, the LLMs/SLMs/VLMs/MMLMs/etc., such as one or more language models 112 with reference to FIG. 1, may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data may be provided with the same input query and prompt (e.g., set of constraints, conditioners, etc.). In one or more implementations, the language models may be different versions of the same foundation model. In one or more implementations, at least one language model may be instantiated as multiple agents—e.g., more than one prompt may be provided to constrain, direct, or otherwise influence a style, a content, or a character, etc., of the output provided. In one or more example, non-limiting implementations, the same language model may be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more implementations, the output from one language model—or version, instance, or agent—maybe be provided as input to another language model for further processing and/or validation. For example, the output of one or more language models 112 may be provided as input to another one or more language models 112 as described with reference to FIG. 1. In one or more implementations, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more implementations, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 3A is a block diagram of an example generative language model system 300 suitable for use in implementing at least some implementations of the present disclosure with reference to FIG. 1. In the example illustrated in FIG. 3A, the generative language model system 300 includes a retrieval augmented generation (RAG) component 392, an input processor 305, a tokenizer 310, an embedding component 320, plug-ins/APIs 395, and a generative language model (LM) 330 (which may include an LLM, a SLM, a VLM, a multi-modal LM, etc.).

At a high level, the input processor 305 may receive an input 301 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 330 (e.g., LLM/SLM/VLM/MMLM/etc.). The input processor 305 may receive input data 104 with reference to FIG. 1. In some implementations, the input 301 includes plain text in the form of one or more sentences, paragraphs, and/or documents. Additionally or alternatively, the input 301 may include numerical sequences, precomputed embeddings (e.g., word or sentence embeddings), and/or structured data (e.g., in tabular formats, JSON, or XML). In some implementations in which the generative LM 330 is capable of processing multi-modal inputs, the input 301 may combine text (or may omit text) with image data, audio data, video data, design data, USD data, and/or other types of input data, such as but not limited to those described herein. Taking raw input text as an example, the input processor 305 may prepare raw input text in various ways. For example, the input processor 305 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 305 may remove stopwords to reduce noise and focus the generative LM 330 on more meaningful content. The input processor 305 may apply text normalization, for example, by converting all characters to lowercase, removing accents, and/or or handling special cases like contractions or abbreviations to ensure consistency. These are just a few examples, and other types of input processing may be applied.

In some implementations, a RAG component 392 (which may include one or more RAG models, and/or may be performed using the generative LM 330 itself) may be used to retrieve additional information to be used as part of the input 301 or prompt. RAG may be used to enhance the input to the LLM/SLM/VLM/MMLM/etc. with external knowledge, so that answers to specific questions or queries or requests are more relevant—such as in a case where specific knowledge is required. The RAG component 392 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 301 may be generated using the query or input to the model (e.g., a question, a request, etc.) in addition to data retrieved using the RAG component 392. In some implementations, the input processor 305 may analyze the input 301 and communicate with the RAG component 392 (or the RAG component 392 may be part of the input processor 305, in implementations) in order to identify relevant text and/or other data to provide to the generative LM 330 as additional context or sources of information from which to identify the response, answer, or output 390, generally. For example, where the input indicates that the user is interested in a desired tire pressure for a particular make and model of vehicle, the RAG component 392 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 392 may retrieve a prior stored conversation history—or at least a summary thereof—and include the prior conversation history along with the current ask/request as part of the input 301 to the generative LM 330.

The RAG component 392 may use various RAG techniques. For example, naíve RAG may be used where documents are indexed, chunked, and applied to an embedding model to generate embeddings corresponding to the chunks. A user query may also be applied to the embedding model and/or another embedding model of the RAG component 392 and the embeddings of the chunks along with the embeddings of the query may be compared to identify the most similar/related embeddings to the query, which may be supplied to the generative LM 330 to generate an output.

In some implementations, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naíve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, may contain relevant textual content and metadata about the knowledge graph as well as be integrated with a vector database. In some implementations, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some implementations, graph RAG (e.g., using a graph database) may be combined with standard (e.g., vector database) RAG, and/or other RAG types, to benefit from multiple approaches.

In any implementations, the RAG component 392 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 310 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 330 to understand morphological variations and handle out-of-vocabulary words more effectively. Character-based tokenization represents each character as a separate token, enabling the generative LM 330 to process text at a fine-grained level. The choice of tokenization strategy may depend on factors such as the language being processed, the task at hand, and/or characteristics of the training dataset. As such, the tokenizer 310 may convert the (e.g., processed) text into a structured format according to tokenization schema being implemented in the particular implementation.

The embedding component 320 may use any known embedding technique to transform discrete tokens into (e.g., dense, continuous vector) representations of semantic meaning. For example, the embedding component 320 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 301, such as input data 104 with reference to FIG. 1, includes image data/video data/etc., the input processor 301 may resize the data to a standard size compatible with format of a corresponding input channel and/or may normalize pixel values to a common range (e.g., 0 to 1) to ensure a consistent representation, and the embedding component 320 may encode the image data using any known technique (e.g., using one or more convolutional neural networks (CNNs) to extract visual features). In some implementations in which the input 301 includes audio data, the input processor 301 may resample an audio file to a consistent sampling rate for uniform processing, and the embedding component 320 may use any known technique to extract and encode audio features—such as in the form of a spectrogram (e.g., a mel-spectrogram). In some implementations in which the input 301 includes video data, the input processor 301 may extract frames or apply resizing to extracted frames, and the embedding component 320 may extract features such as optical flow embeddings or video embeddings and/or may encode temporal information or sequences of frames. In some implementations in which the input 301 includes multi-modal data, the embedding component 320 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 330 and/or other components of the generative LM system 300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 320 may apply an encoded representation of the input 301 to the generative LM 330, and the generative LM 330 may process the encoded representation of the input 301 to generate an output 390, which may include responsive text and/or other types of data.

As described herein, in some implementations, the generative LM 330 may be configured to access or use—or capable of accessing or using—plug-ins/APIs 395 (which may include one or more plug-ins, application programming interfaces (APIs), databases, data stores, repositories, etc.). For example, for certain tasks or operations that the generative LM 330 is not ideally suited for, the model may have instructions (e.g., as a result of training, and/or based on instructions in a given prompt, such as those retrieved using the RAG component 392) to access one or more plug-ins/APIs 395 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 395 to the plug-in/API 395, the plug-in/API 395 may process the information and return an answer to the generative LM 330, and the generative LM 330 may use the response to generate the output 390. This process may be repeated —e.g., recursively—for any number of iterations and using any number of plug-ins/APIs 395 until an output 390 that addresses each ask/question/request/process/operation/etc. from the input 301 can be generated. As such, the model(s) may not only rely on its own knowledge from training on a large dataset(s) and/or from data retrieved using the RAG component 392, but also on the expertise or optimized nature of one or more external resources-such as the plug-ins/APIs 395.

FIG. 3B is a block diagram of an example implementation in which the generative LM 330 includes a transformer encoder-decoder. For example, assume input text such as “Who discovered gravity” is tokenized (e.g., by the tokenizer 310 of FIG. 3A) into tokens such as words, and each token is encoded (e.g., by the embedding component 320 of FIG. 3A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 335 of the generative LM 330.

In an example implementation, the encoder(s) 335 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 340 may convert the context vector into attention vectors (keys and values) for the decoder(s) 345.

In an example implementation, the decoder(s) 345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 335, in an example transformer architecture, each token (e.g., word) flows through a separate path in the decoder(s) 345. During a first pass, the decoder(s) 345, a classifier 350, and a generation mechanism 355 may generate a first token, and the generation mechanism 355 may apply the generated token as an input during a second pass. The process may repeat in a loop, successively generating and adding tokens (e.g., words) to the output from the preceding pass and applying the token embeddings of the composite sequence with positional encodings as an input to the decoder(s) 345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 335, except that it creates its queries from the layer below it and takes the keys and values (e.g., matrix) from the output of the encoder(s) 335.

As such, the decoder(s) 345 may output some decoded (e.g., vector) representation of the input being applied during a particular pass. The classifier 350 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 355 may select or sample a word or token based on a corresponding predicted probability (e.g., select the word with the highest predicted probability) and append it to the output from a previous pass, generating each word or token sequentially. The generation mechanism 355 may repeat the process, triggering successive decoder inputs and corresponding predictions until selecting or sampling a symbol or token that represents the end of the response, at which point, the generation mechanism 355 may output the generated response.

FIG. 3C is a block diagram of an example implementation in which the generative LM 330 includes a decoder-only transformer architecture. For example, the decoder(s) 360 of FIG. 3C may operate similarly as the decoder(s) 345 of FIG. 3B except each of the decoder(s) 360 of FIG. 3C omits the encoder-decoder self-attention layer (since there is no encoder in this implementation). As such, the decoder(s) 360 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 360. As with the decoder(s) 345 of FIG. 3B, each token (e.g., word) may flow through a separate path in the decoder(s) 360, and the decoder(s) 360, a classifier 365, and a generation mechanism 370 may use auto-regression to sequentially generate one token at a time until predicting a symbol or token that represents the end of the response. The classifier 365 and the generation mechanism 370 may operate similarly as the classifier 350 and the generation mechanism 355 of FIG. 3B, with the generation mechanism 370 selecting or sampling each successive output token based on a corresponding predicted probability and appending it to the output from a previous pass, generating each token sequentially until selecting or sampling a symbol or token that represents the end of the response. These architectures can be implemented within the system 100 as described with reference to FIG. 1. These and other architectures described herein are meant simply as examples, and other suitable architectures may be implemented within the scope of the present disclosure.

### EXAMPLE COMPUTING DEVICE

FIG. 4 is a block diagram of an example computing device(s) 400 suitable for use in implementing some implementations of the present disclosure with reference to FIG. 1. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one implementation, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some implementations, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor, and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In implementations, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In implementations, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In implementations, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that allow the computing device 400 to communicate with other computing devices via an electronic communication network, included wired and/or wireless communications. The communication interface 410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may allow the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that allow detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to allow the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.). One or more of these computer devices can be implemented within the system 100 as described with reference to FIG. 1.

### EXAMPLE DATA CENTER

FIG. 5 illustrates an example data center 500 that may be used in at least one implementations of the present disclosure with reference to FIG. 1. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R. s”) 516(1)-516(N), where “N” represents any whole, positive integer. In at least one implementation, node C.R. s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R. s from among node C.R. s 516(1)-516(N) may correspond to a server having one or more of the above-mentioned computing resources. In addition, in some implementations, the node C.R. s 516(1)-5161(N) may include one or more virtual components, such as vGPUs, vCPUs, and/or the like, and/or one or more of the node C.R. s 516(1)-516(N) may correspond to a virtual machine (VM).

In at least one implementation, grouped computing resources 514 may include separate groupings of node C.R. s 516 housed within one or more racks (not shown), or many racks housed in data centers at various geographical locations (also not shown). Separate groupings of node C.R. s 516 within grouped computing resources 514 may include grouped compute, network, memory or storage resources that may be configured or allocated to support one or more workloads. In at least one implementation, several node C.R. s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one implementation, resource orchestrator 512 may include a software design infrastructure (SDI) management entity for the data center 500. The resource orchestrator 512 may include hardware, software, or some combination thereof.

In at least one implementation, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™(hereinafter “Spark”) that may use distributed file system 538 for large-scale data processing (e.g., “big data”). In at least one implementation, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one implementation, clustered or grouped computing resources may include grouped computing resource 514 at data center infrastructure layer 510. The resource manager 536 may coordinate with resource orchestrator 512 to manage these mapped or allocated computing resources.

In at least one implementation, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one implementation, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models, such as one or more language models 112, or predict or infer information using one or more machine learning models according to one or more implementations described herein. For example, a machine learning model(s) may be trained by calculating weight parameters according to a neural network architecture using software and/or computing resources described above with respect to the data center 500. In at least one implementation, trained or deployed machine learning models corresponding to one or more neural networks may be used to infer or predict information using resources described above with respect to the data center 500 by using weight parameters calculated through one or more training techniques, such as but not limited to those described herein.

In at least one implementation, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing implementations of the disclosure with reference to FIG. 1 may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device. The network environments as described herein can be implemented into the system 100 of the present disclosure with reference to FIG. 1.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
receive a caption regarding an image;
generate, responsive to detecting that the caption includes at least a threshold amount of text, based at least on applying text recognition to the image, text data represented in the image; and
cause at least one language model to generate an annotation for the image based at least on the caption, the text data, an example query for the at least one language model to process, and an example response corresponding to the example query.

2. The one or more processors of claim 1, wherein the processing circuitry is to apply the image as input to a vision language model to cause the vision language model to generate the caption.

3. The one or more processors of claim 1, wherein the processing circuitry is to:
generate a plurality of clusters of a plurality of candidate images according to visual similarity amongst the plurality of candidate images;
remove at least one candidate image from one or more clusters of the plurality of clusters to retain a subset of candidate images for the one or more clusters; and
retrieve the image from the subset of candidate images.

4. The one or more processors of claim 1, wherein the processing circuitry is to:
apply the caption and the image as input to the at least one language model to cause the at least one language model to generate an accuracy score regarding the caption;
provide a request for a manual caption of the image responsive to the accuracy score being less than an accuracy threshold; and
cause the at least one language model, responsive to receiving the manual caption, to generate the annotation according to the manual caption.

5. The one or more processors of claim 1, wherein the processing circuitry is to cause the at least one language model to generate the annotation by performing in-context learning using the caption, the text data, the example query, and the example response.

6. The one or more processors of claim 1, wherein the processing circuitry is to cause the at least one language model to generate the annotation to include a question regarding the image and an answer to the question.

7. The one or more processors of claim 1, wherein the one or more processors are comprised in at least one of:
a system for generating synthetic data;
a system implementing one or more large language models (LLMs);
a system implementing one or more small language models (SLMs);
a system implementing one or more vision language models (VLMs);
a system for performing conversational AI operations;
a system implementing one or more multi-model language models;
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data using AI;
a system incorporating one or more virtual machines (VMs);
a system implemented at least partially in a data center; or
a system implemented at least partially using cloud computing resources.

8. A system comprising one or more processors to:
receive a caption regarding an image;
generate, responsive to detecting that the caption includes at least a threshold amount of text, based at least on applying text recognition to the image, text data represented in the image; and
cause at least one language model to generate an annotation for the image based at least on the caption, the text data, and an example query-response pair, such that the annotation corresponds to the example query-response pair.

9. The system of claim 8, wherein the one or more processors are to apply the image as input to a vision language model to cause the vision language model to generate the caption.

10. The system of claim 8, wherein the one or more processors are to:
generate a plurality of clusters of a plurality of candidate images according to visual similarity amongst the plurality of candidate images;
remove at least one candidate image from one or more clusters of the plurality of clusters to retain a subset of candidate images for the one or more clusters; and
retrieve the image from the subset of candidate images.

11. The system of claim 8, wherein the one or more processors are to:
apply the caption and the image as input to the at least one language model to cause the at least one language model to generate an accuracy score regarding the caption;
provide a request for a manual caption of the image responsive to the accuracy score being less than an accuracy threshold; and
cause the at least one language model, responsive to receiving the manual caption, to generate the annotation according to the manual caption.

12. The system of claim 8, wherein the one or more processors are to cause the at least one language model to generate the annotation by performing in-context learning using the caption, the text data, and the example query-response pair.

13. The system of claim 8, wherein the one or more processors are to cause the at least one language model to generate the annotation to include a question regarding the image and an answer to the question.

14. The system of claim 8, wherein the one or more processors are comprised in at least one of:
a system for generating synthetic data;
a system implementing one or more large language models (LLMs);
a system implementing one or more small language models (SLMs);
a system implementing one or more vision language models (VLMs);
a system for performing conversational AI operations;
a system implementing one or more multi-model language models;
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data using AI;
a system incorporating one or more virtual machines (VMs);
a system implemented at least partially in a data center; or
a system implemented at least partially using cloud computing resources.

15. A method, comprising:
retrieving a caption of an image;
performing optical character recognition on the image responsive to the caption having greater than a threshold amount of text, to generate text data of the image; and
generating, using at least one neural network, an annotation for the image according to the text data, the image, and natural language data representing an example of the annotation.

16. The method of claim 15, further comprising modifying the caption according to user input regarding the image.

17. The method of claim 15, further comprising generating the caption by applying the image as input to a vision language model.

18. The method of claim 15, further comprising updating at least one language model using the annotation.

19. The method of claim 15, further comprising selecting the image according to a visual characteristic of the image relative to a plurality of candidate images.

20. The method of claim 15, wherein the method is implemented in at least one of:
a system for generating synthetic data;
a system implementing one or more large language models (LLMs);
a system implementing one or more small language models (SLMs);
a system implementing one or more vision language models (VLMs);
a system for performing conversational AI operations;
a system implementing one or more multi-model language models;
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data using AI;
a system incorporating one or more virtual machines (VMs);
a system implemented at least partially in a data center; or
a system implemented at least partially using cloud computing resources.
